(19) United States
(12) Patent Application Publication
(10) Pub. No.: US 2026/0195670 A1
(43) Pub. Date: Jul. 9, 2026

(54) HOME SECURITY COMMUNICATION SYSTEM

(71) Applicant: Piranha Security, LLC d/b/a Crassus Security, Denver, CO (US)

(72) Inventor: Dominique Journet, Denver, CO (US)

(21) Appl. No.: 19/444,698

(22) Filed: Jan. 9, 2026

Related U.S. Application Data
(60) Provisional application No. 63/743,466, filed on Jan. 9, 2025.

(51) Int. Cl. G06Q 10/0631; G06Q 30/018; H04L 67/02; H04W 4/021; H04W 64/00

(52) U.S. Cl. CPC G06Q 10/06311; G06Q 30/018; H04L 67/02; H04W 4/021; H04W 64/00

(57) ABSTRACT

A home security communication system includes a client application executing on a user device and a security platform comprising a services database populated from schedule databases of one or more service providers. The client application obtains a location of interest and queries the services database to determine whether authorized service-provider personnel are scheduled to be present near that location. The client application presents user interfaces that display status indicators, scheduling and rescheduling options, and identity details of personnel for verification. The system supports secure communications between the client application, the security platform, and service-provider systems using network security protocols and may employ token-based authentication. The client application enables users to request, confirm, and track service-provider activity at their location of interest, enhancing residential security by allowing verification of service-provider presence and identity before granting access.

### CROSS-REFERENCE TO RELATED APPLICATIONS

The present application claims the benefit of priority of U.S. Provisional Application No. 63/743,466, filed Jan. 9, 2025, the contents of which are herein incorporated by reference.

### BACKGROUND

In today's world, where safety is paramount, home invasions represent a chilling reality, often exacerbated by perpetrators posing as utility company employees. These impostors exploit trust to gain unauthorized access to homes, contributing significantly to the staggering statistics surrounding break-ins and burglaries. With over 2,000,000 homes falling victim to such incidents annually and a daily average of 4,500 home burglaries, the need for heightened vigilance is evident. However, this presents a unique opportunity for utility companies to step in and provide essential peace of mind. Such proactive measures enhance residential security and reinforce trust in utility services, offering a vital layer of protection against intruders masquerading as employees.

### SUMMARY

The present disclosure generally relates to a home security communication system that allows a user to obtain verification regarding service provider activity affecting the user. For example, the user may execute a client application on a user device (e.g., their smartphone). The client application may allow the user to identify their location, either using the location determination capabilities of the user device or by entering their address. In turn, users gain immediate access to a comprehensive verification system.

The system is not limited to verifying individual identities. Rather, the system may provide real-time updates on the presence of authorized personnel from a service provider (e.g., a utility company, government service provider, etc.). Through seamless integration with system provider systems, the system leverages geolocation data to inform homeowners of any legitimate representatives operating in their area. This feature enhances the user experience and fosters a proactive approach to security. Armed with this information, homeowners can make informed decisions about granting access to their properties, effectively fortifying their defenses against potential threats. In essence, the system empowers users to take control of their security with unparalleled ease and efficiency, ensuring peace of mind in an ever-evolving landscape of risk uncertainties.

In some aspects, the techniques described herein relate to a method of verifying service-provider activity at a location of interest, the method including: obtaining, by a client application executing on a user device, a location of interest associated with a user; querying, by the client application, a services database of a security platform, the services database populated from one or more schedule databases of service providers; receiving, by the client application, information from the services database indicating whether authorized service-provider personnel are scheduled to be present near the location of interest; and displaying, by the client application, a user interface indicating at least one status of such activity for user verification.

In some aspects, the techniques described herein relate to a system for verifying service-provider activity at a location of interest, the system including: one or more hardware processors; a user device including a client application configured to obtain a location of interest associated with a user; a security platform including a services database populated from one or more schedule databases of service providers, wherein the client application is configured to query the services database using the location of interest to obtain information indicating whether authorized service-provider personnel are scheduled to be present near the location of interest and to present at least a portion of that information to the user for verification.

In some aspects, the techniques described herein relate to one or more tangible processor-readable storage media embodied with instructions for executing on one or more processors and circuits of a computing device a process for verifying service-provider activity at a location of interest, the process including: obtaining, by a client application, a location of interest associated with a user; querying, by the client application, a services database populated from one or more schedule databases of service providers; receiving, by the client application, information from the services database indicating whether authorized service-provider personnel are scheduled to be present near the location of interest; and presenting, by the client application, a user interface enabling verification of service-provider presence.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTION OF THE DRAWINGS

FIG. 1 illustrates an example of a home security communication system that allows users of a user device to verify service provider activity.

FIG. 2 illustrates an example home security application landing screen, showing an address entry card, status indicators, and navigation controls.

FIG. 3 illustrates the landing screen with an inspection status card, confirmation indicator, and rescheduling options.

FIG. 4 illustrates the landing screen with an address card indicating awaiting confirmation, along with controls to confirm or select a date.

FIG. 5 illustrates the landing screen with an inspection date confirmed and a reschedule option.

FIG. 6 illustrates a rescheduling interface with a calendar view, selectable time windows, and a confirmation control.

FIG. 7 illustrates another calendar view for rescheduling, with selectable dates and time windows.

FIG. 8 illustrates the landing screen indicating awaiting confirmation, with a date-selection control.

FIG. 9 illustrates an inspector verification interface, presenting identity details, license information, and validity data.

FIG. 10 illustrates a confirmation dialog presenting an inspection date and time, the assigned inspector, and a control to accept.

FIG. 11 illustrates an example computing device for use in implementing the described technology.

### DETAILED DESCRIPTION

While the invention is susceptible to various modifications and alternative forms, specific embodiments thereof have been shown by way of example in the drawings and are herein described in detail. It should be understood, however, that it is not intended to limit the invention to the particular form disclosed, but rather, the invention is to cover all modifications, equivalents, and alternatives falling within the scope of the invention as defined by the claims.

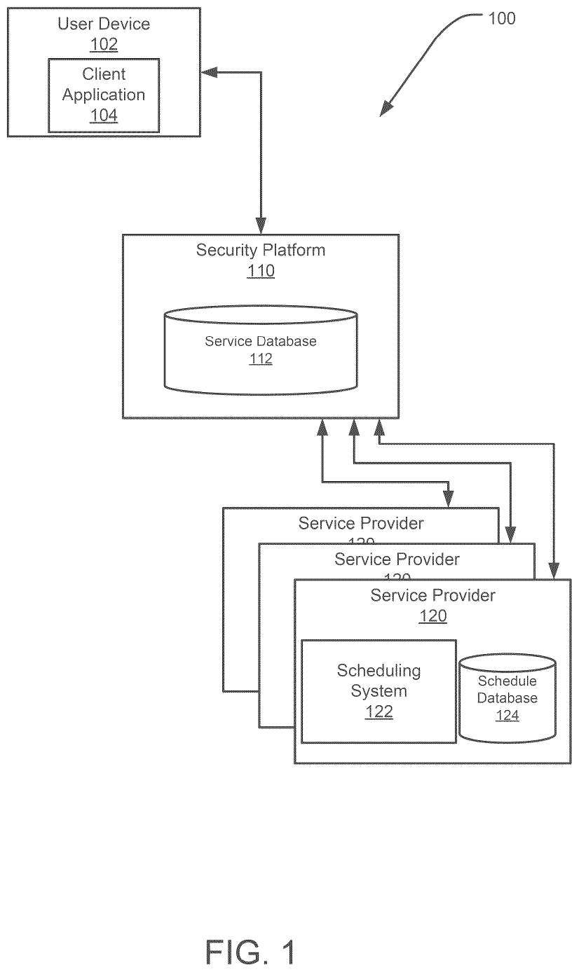

FIG. 1 illustrates an example of a home security communication system 100. The home security communication system 100 may include a user device 102, a security platform 110, and one or more service providers 120. The user device 102 may comprise a computing device in the possession of a user, such as a homeowner. For example, the user device 102 may comprise a personal computer, smartphone device, tablet device, or the like. The user device 102 may execute a client application 104. The client application 104 may leverage the capabilities of the user device 102 to obtain a location associated with the user. For example, the client application 104 may access location services of the user device 102 (e.g., using GPS technology) to obtain a location of the user device 102.

The client application 104 may comprise a native application executing on the user device 102. In other examples, the client application 104 may utilize Kotlin Multiplatform (KMP) or React Native to provide functionality. Kotlin Multiplatform allows shared business logic and core functionalities across different platforms while enabling each platform's unique features and UI standards. By using KMP, one may write shared code (e.g., algorithms for location verification or security protocols) while allowing platform-specific code to access native capabilities, such as handling GPS data securely or leveraging native encryption libraries. KMP is especially advantageous for balancing efficient code reuse with high-performance native execution, making it an ideal choice if you want to streamline development without sacrificing platform-specific optimizations. React Native offers a shared codebase for different platforms while maintaining native access through bridging modules, making it a good choice for consistent UI/UX across devices and rapid updates. With React Native, one can develop a single application that leverages location services, GPS data, and real-time notifications while interacting with native security features, ensuring security standards without duplicating efforts for each platform. This option also supports rapid prototyping and deployment, as updates to the UI and business logic can be managed from a single codebase, reducing the overall time and resources needed for maintenance and enhancement.

The client application 104 may communicate with a security platform 110. The security platform 110 may include a services database 112 that includes information regarding areas in which representatives of the one or more service providers 120 are expected to be working. The services database 112 may be populated by information obtained from the one or more service providers 120.

For example, the one or more service providers 120 may employ a scheduling system 122. The scheduling system 122 may be used by the one or more service providers 120 to assign workers tasks or areas of coverage associated with a location or area. In turn, information from the scheduling system 122 may be provided to a schedule database 124 at the one or more service providers 120. The schedule database 124 may include a selective subset of information sufficient to provide verification of whether workers are scheduled to be in a given location, the identities of the workers, the type of work scheduled to be performed, or other pertinent information, which may include less than all information available in the scheduling system 122.

As may be appreciated, each of the one or more service providers 120 may include a schedule database 124 that may be accessible by the security platform 110. In this regard, the services database 112 may be populated with information regarding the schedule database 124 of the one or more service providers 120. As such, the client application 104 may provide information regarding a location of interest (e.g., a location obtained via location services of the user device 102 or provided via an input to the user device 102 by the user). The location of interest may be indexed to the services database 112 to retrieve information about any scheduled workers to be in the location of interest.

The one or more service providers 120 may connect to the security platform 110 through an API or a secure messaging protocol. They could use RESTful or GraphQL APIs for exchanging information. A service provider's internal architecture may include the scheduling database 124 for tracking employee assignments and a middleware layer to relay specific data to the security platform. Service providers might use secure database replication or a publish-subscribe messaging system to update the security platform about real-time changes in worker schedules. In any regard, the systems of the one or more service providers 120 may periodically or event-driven, update the security platform 110 with location-specific data, including authorized personnel, tasks, and schedules.

A user of the user device 102 may access the client application 104 to provide the location of interest and retrieve information from the services database 112 at the security platform 110 regarding workers scheduled to be in the location of interest. This may allow the user to determine if purported work at a location of interest or a request to access the location of interest is legitimate. Furthermore, the services database 112 may provide the client application 104 information regarding the identities of the scheduled workers, which may allow the user to cross-reference the identity information from the services database 112 with identity documents proffered by a worker at the location of interest. That is, upon a user's request, the security platform 110 may verify and relay relevant data about the presence of the one or more service providers 120 near the user's location, using minimal data necessary for security.

The security platform 110 may access the schedule database 124 of the one or more service providers 120 using one or more communication protocols. For example, the security platform 110 may access the schedule database 124 using an application protocol interface (API) defined by each one of the one or more service providers 120 or by the security platform 110. That is, the security platform 110 may publish an API that may be followed by the one or more service providers 120 as partners of the security platform 110 to provide the security platform 110 with access to the respective schedule database 124 of the one or more service providers 120.

In addition, the security platform 110 may facilitate secure communications between the one or more service providers 120 and the user device 102 to provide point-to-point security. This may reduce the potential of malicious actors spoofing one or more service providers 120 or the security platform 110 to provide false information to the client application 104. Secure communications may be provided using any appropriate secure communication protocol, including, for example, hypertext transfer protocol secure (HTTPS). Other means of secure data exchange may be provided, including encrypted communication between the security platform 110 and one or more service providers 120 or between the security platform 110 and the client application 104.

The security platform 110 may be implemented using a monolithic architecture, Fastify, and/or NestJS. For example, the security platform 110 may utilize a TypeScript-based monolithic architecture using Fastify or NestJS. This approach centralizes all application logic, databases, and APIs within a single deployable unit, streamlining management and development processes. A monolithic architecture allows one to maintain all services (user authentication, data processing, API handling, and secure communications) in a single codebase. This can be easier to manage in early development stages, especially when performance and consistency are critical. In a security-oriented application, a monolithic design centralizes critical security configurations and protocols, making it simpler to enforce security measures, monitor activity, and update the system without impacting distributed microservices. With TypeScript's static typing, maintaining a large, cohesive codebase becomes more manageable, reducing errors and enhancing code reliability.

Fastify's plugin architecture fits well within a monolithic structure, allowing one to add middleware, authentication, and rate-limiting plugins across all routes without the complexity of inter-service communication. Fastify's JSON schema validation ensures data integrity throughout the monolithic application, which is essential when handling sensitive data like location updates or verification requests. NestJS's modularity provides a structured approach to organizing different parts of the application within a monolithic framework, creating clear boundaries for modules like authentication, user management, and service provider integration. The dependency injection and middleware support in NestJS simplify security enforcement across modules in the monolith, making it easier to apply consistent security protocols like JWT authentication or HTTPS across the entire application.

A monolithic architecture may be suitable if one expects a manageable volume of requests initially and needs high-speed communication between modules. By keeping the entire application under one deployable unit, response times can be optimized without the latency of inter-service calls. This approach can also facilitate easier scaling at the infrastructure level. For instance, you can deploy the monolithic platform behind a load balancer and horizontally scale it to meet demand. A monolithic TypeScript platform using Fastify or NestJS offers a straightforward, maintainable, and high-performance option for a real-time security system. It provides centralized control over security protocols and simplifies deployment, making it a practical choice as the system grows and evolves.

All data exchange within the home security communication system 100 may be secured with end-to-end encryption (e.g., TLS 1.3), ensuring that data between user devices 102, the security platform 110, and the one or more service providers 120 cannot be intercepted or tampered with. Additionally or alternatively, the security platform 110 could generate JWT (JSON Web Tokens) for authenticating user device requests, with tokens expiring at regular intervals to mitigate risks if a device is compromised.

The client application 104 may provide the capability for the user to request, confirm, and track various services to be performed at the location of the user. The security platform 110 may provide a connection between the client application 104 and the scheduling system 122 to allow the user of the client application 104 to interact with the one or more service providers 120 to request and schedule services. Further still, the scheduling system 122 may provide notices to the client application 104 based on scheduled or unscheduled work to be performed at the location of interest as defined by the user in the client application 104.

As noted above, the client application 104 may comprise an application executing on the user device 102, which may be a smartphone device.

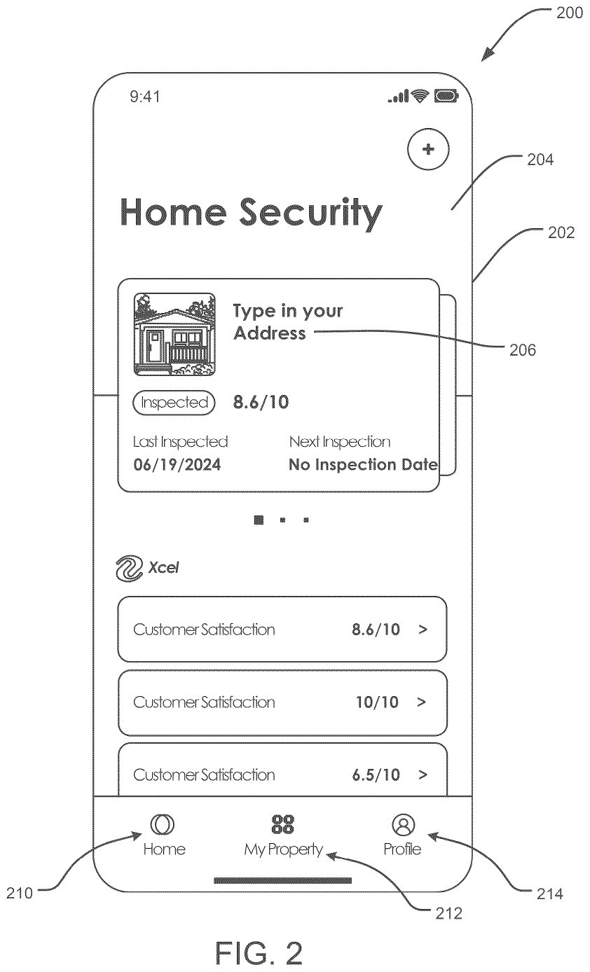

FIGS. 2-10 present example user interfaces for the client application 104 as presented on a smartphone device. The user interfaces of FIGS. 2-10 may facilitate the functionality described above.

FIG. 2 shows a landing screen of the client application 200. The screen 202 includes a header region 204, an address card 206 for entering or confirming a location of interest, and bottom navigation controls 210, 212, and 214 for home, property, and profile functions, respectively. The client application populates these fields using information obtained from the security platform and the services database.

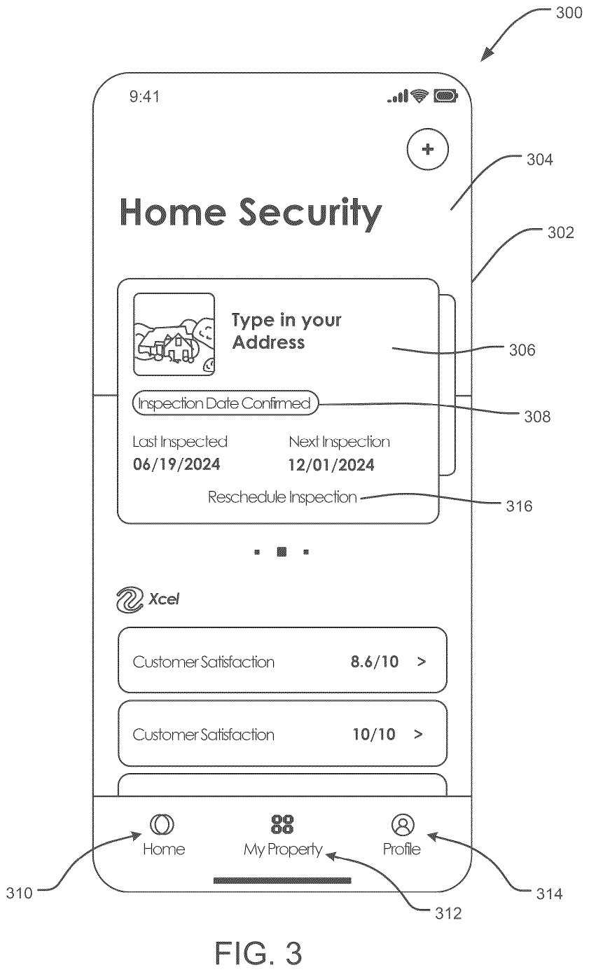

FIG. 3 shows a landing screen of the client application 300. The screen 302 includes a header region 304, an address entry field 306 prompting the user to type in their address, a status message or indicator 308 related to inspection scheduling, a button or control 316 to reschedule the inspection, and Bottom navigation controls 310, 312, and 314 for home, property, and profile functions, respectively.

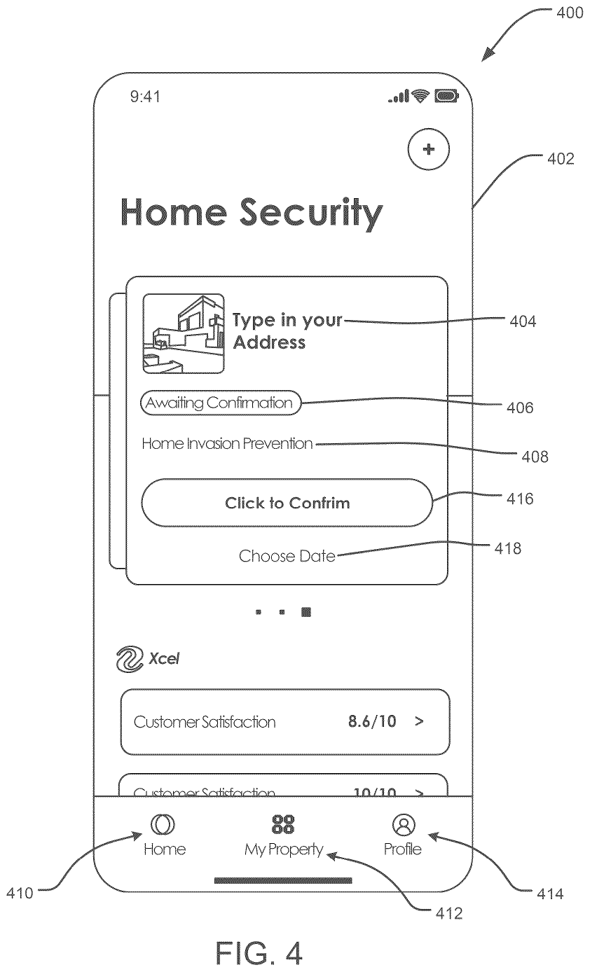

FIG. 4 shows a user interface 400 with a screen 402 that includes an address card 404, an awaiting confirmation indicator 406, a service message 408, a confirmation control 410, and a choose-date control 412. Bottom navigation controls 410, 412, and 414 for home, property, and profile functions, respectively, are again provided.

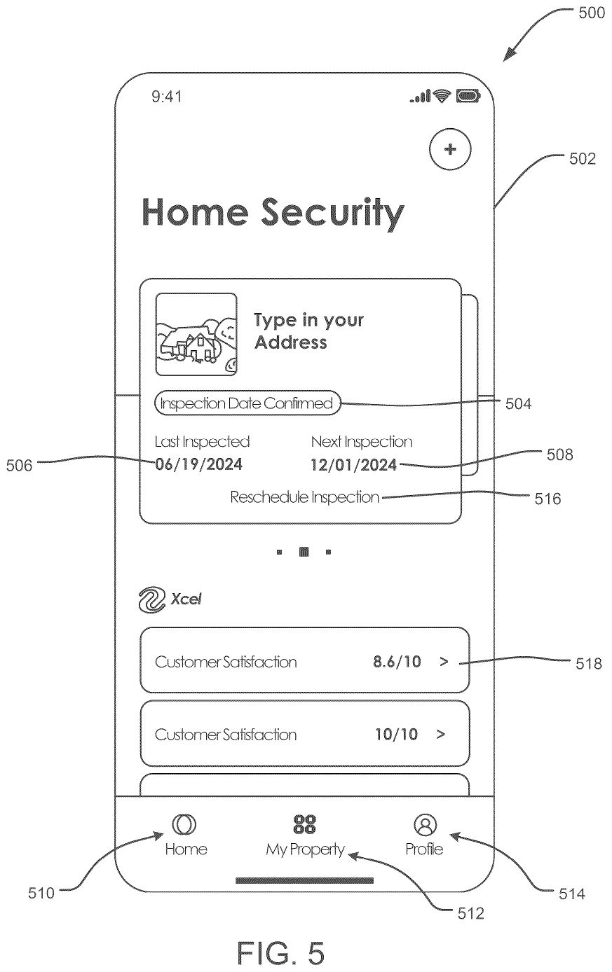

FIG. 5 shows a user interface 500 with a screen 502 including an inspection confirmed card 504, a last inspection date field 506, a next inspection date field 508, and a reschedule control 516, with a provider summary region 518. Bottom navigation controls 510, 512, and 514 for home, property, and profile functions, respectively, are again provided.

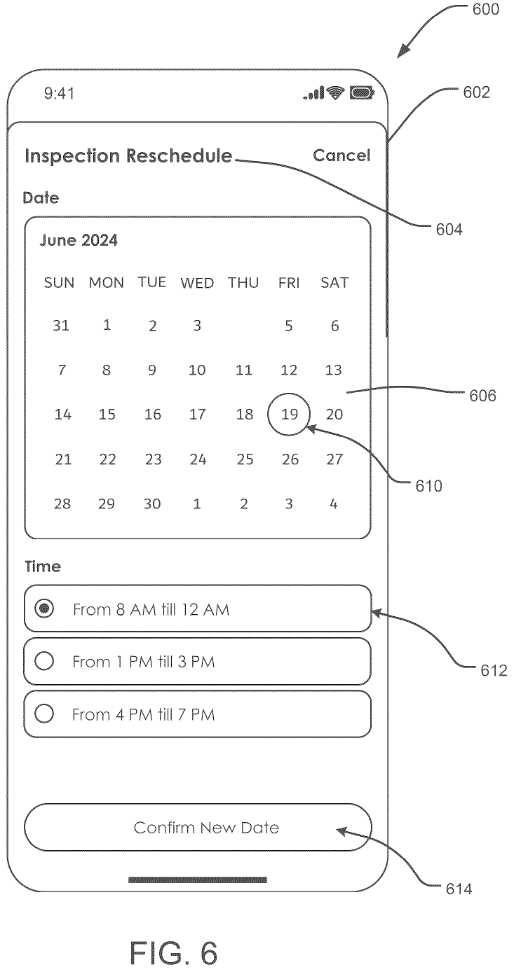

FIG. 6 shows a user interface 600 with a screen 602 that presents an inspection reschedule view 604 including a calendar component 606, a selected date indicator 610, time-window selectors 612, and a confirm control 614.

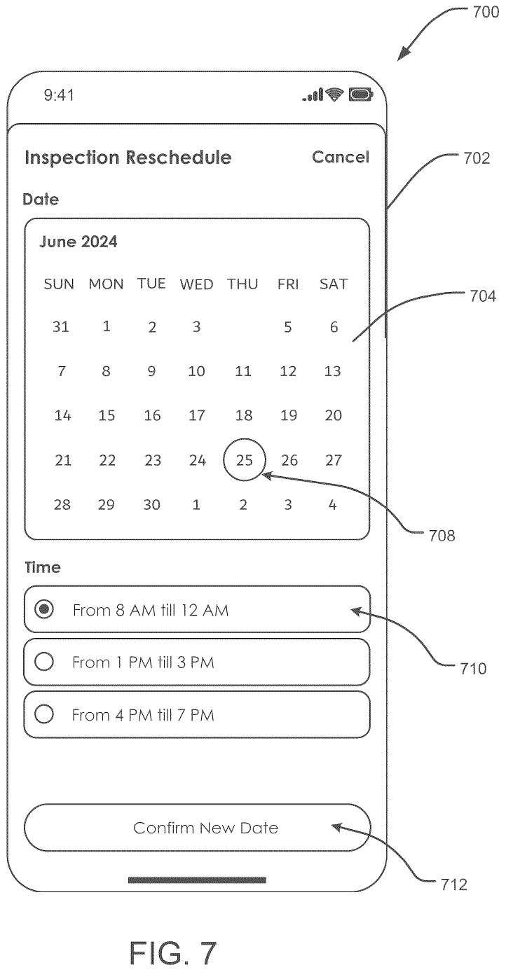

FIG. 7 shows a user interface 700 with a screen 702 presenting a calendar component 704, a selected date indicator 708, time-window selectors 710, and a confirm control 712.

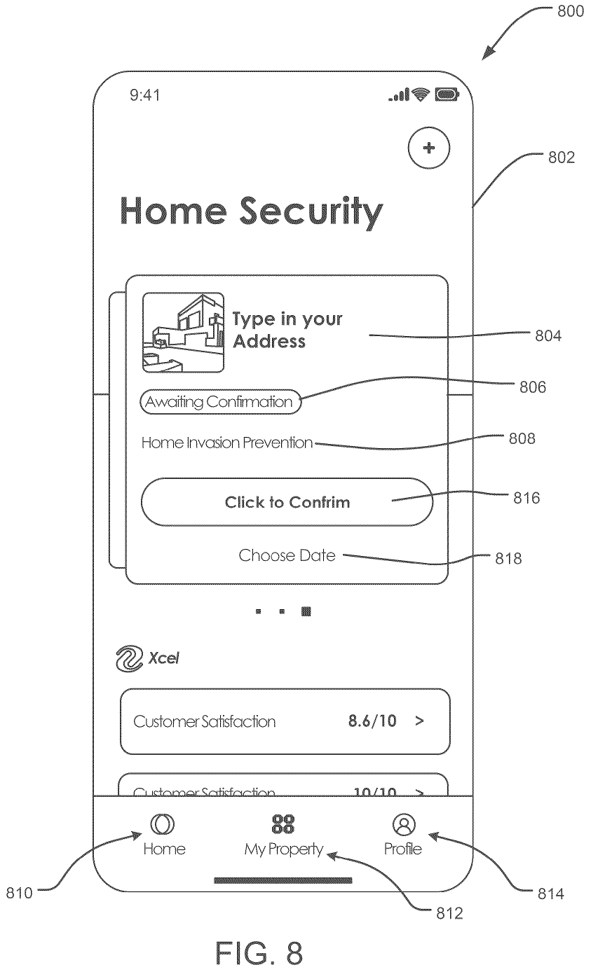

FIG. 8 shows a user interface 800 with a screen 802 that includes an address card 804, an awaiting confirmation indicator 806, a service message 808, a confirmation control 816, and a choose-date control 818 with bottom navigation controls 812, 812, 814.

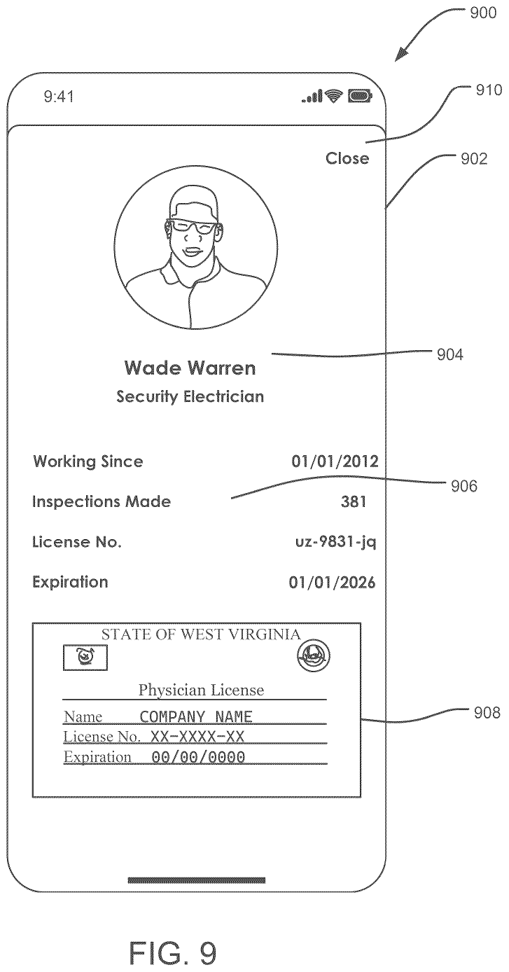

FIG. 9 shows a user interface 900 with a screen 902 presenting inspector credential details. The interface includes a panel 906 with fields for the inspector's name, employment or tenure, inspection mode, license identifier, and expiration date. An identification card region 908 displays these details in a structured format, and a close control 910 allows the user to dismiss the screen. The interface enables the user to review and verify the credentials of the service provider personnel.

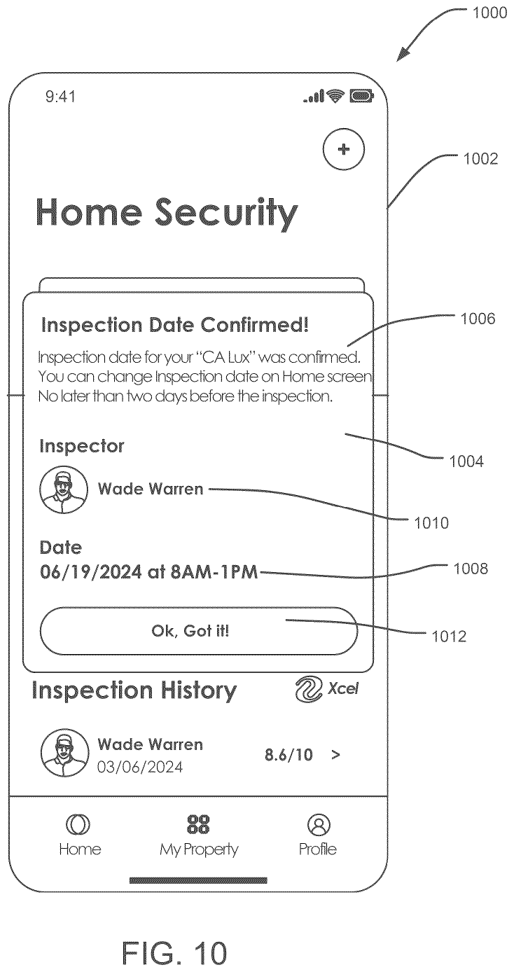

FIG. 10 shows a user interface 1000 with a screen 1002 including a confirmation dialog 1004 that conveys an inspection confirmation message 1006, a date and time field 1008, an assigned inspector field 1010, and action control 1012.

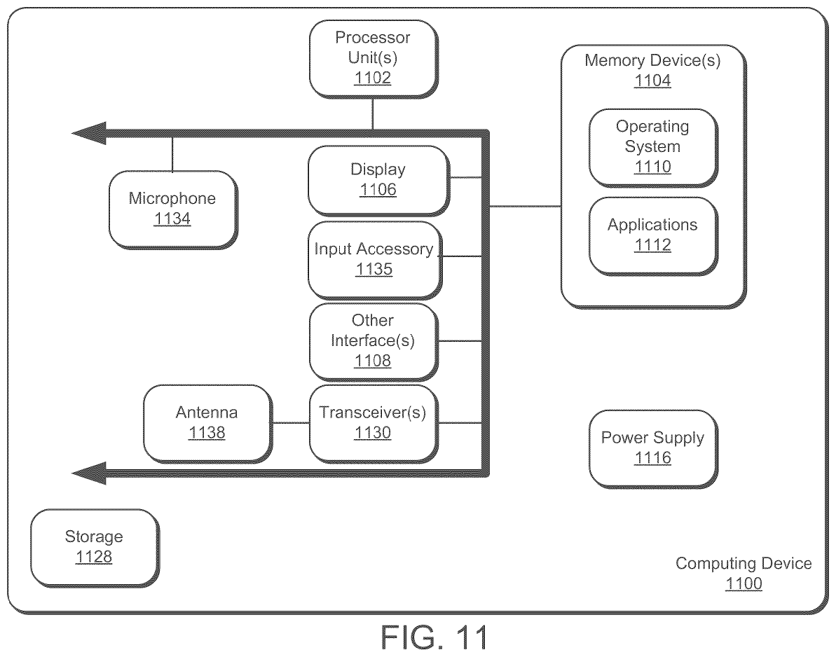

FIG. 11 illustrates an example schematic of a computing device 1100 suitable for implementing aspects of the disclosed technology including the user device 102, the security platform 110, the scheduling system 122, or other computing device as described above. The computing device 1100 includes one or more processor unit(s) 1102, memory 1104, a display 1106, and other interfaces 1108 (e.g., buttons). The memory 1104 generally includes both volatile memory (e.g., RAM) and non-volatile memory (e.g., flash memory). An operating system 1110, such as the Microsoft Windows® operating system, the Apple macOS operating system, or the Linux operating system, resides in the memory 1104 and is executed by the processor unit(s) 1102, although it should be understood that other operating systems may be employed.

One or more applications 1112 are loaded in the memory 1104 and executed on the operating system 1110 by the processor unit(s) 1102. Applications 1112 may receive input from various input local devices such as a microphone 1134, input accessory 1135 (e.g., keypad, mouse, stylus, touchpad, joystick, instrument mounted input, or the like). Additionally, the applications 1112 may receive input from one or more remote devices such as remotely-located smart devices by communicating with such devices over a wired or wireless network using more communication transceivers 1130 and an antenna 1138 to provide network connectivity (e.g., a mobile phone network, Wi-Fi®, Bluetooth®). The computing device 1100 may also include various other components, such as a positioning system (e.g., a global positioning satellite transceiver), one or more accelerometers, one or more cameras, an audio interface (e.g., the microphone 1134, an audio amplifier and speaker and/or audio jack), and storage devices 1128. Other configurations may also be employed.

The computing device 1100 further includes a power supply 1116, which is powered by one or more batteries or other power sources and which provides power to other components of the computing device 1100. The power supply 1116 may also be connected to an external power source (not shown) that overrides or recharges the built-in batteries or other power sources.

In an example implementation, the computing device 1100 comprises hardware and/or software embodied by instructions stored in the memory 1104 and/or the storage devices 1128 and processed by the processor unit(s) 1102. The memory 1104 may be the memory of a host device or of an accessory that couples to the host. Additionally or alternatively, the computing device 1100 may comprise one or more field programmable gate arrays (FGPAs), application specific integrated circuits (ASIC), or other hardware/software/firmware capable of providing the functionality described herein.

The computing device 1100 may include a variety of tangible processor-readable storage media and intangible processor-readable communication signals. Tangible processor-readable storage can be embodied by any available media that can be accessed by the computing device 1100 and includes both volatile and nonvolatile storage media, removable and non-removable storage media. Tangible processor-readable storage media excludes intangible communications signals and includes volatile and nonvolatile, removable and non-removable storage media implemented in any method or technology for storage of information such as processor-readable instructions, data structures, program modules or other data. Tangible processor-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information and which can be accessed by the computing device 1100. In contrast to tangible processor-readable storage media, intangible processor-readable communication signals may embody processor-readable instructions, data structures, program modules or other data resident in a modulated data signal, such as a carrier wave or other signal transport mechanism. The term “modulated data signal” means an intangible communications signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

Some implementations may comprise an article of manufacture. An article of manufacture may comprise a tangible storage medium to store logic. Examples of a storage medium may include one or more types of processor-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described implementations. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain operation segment. The instructions may be implemented using any suitable high-level, low-level, object-oriented, visual, compiled and/or interpreted programming language.

While this specification contains many specific implementation details, these should not be construed as limitations on the scope of any technologies or of what may be claimed, but rather as descriptions of features specific to particular implementations of the particular described technology. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

A number of implementations of the described technology have been described. Nevertheless, it will be understood that various modifications can be made without departing from the spirit and scope of the recited claims.

What is claimed is:

1. A method of verifying service provider activity at a location of interest, the method comprising:
obtaining, by a client application executing on a user device, a location of interest associated with a user;
querying, by the client application, a services database of a security platform, the services database populated from one or more schedule databases of service providers;
receiving, by the client application, information from the services database indicating whether authorized service provider personnel are scheduled to be present near the location of interest; and
displaying, by the client application, a user interface indicating at least one status of such activity for user verification.

2. The method of claim 1, further comprising presenting, by the client application, a calendar interface with selectable dates and time windows to schedule or reschedule service activity.

3. The method of claim 1, wherein the displaying includes presenting an inspection confirmation dialog including a date, a time, and an assigned personnel field.

4. The method of claim 1, further comprising generating, by the security platform, notices to the client application based on scheduled or unscheduled work at the location of interest.

5. The method of claim 1, further comprising verifying, by the client application, identity documents presented by personnel by cross-referencing identity data received from the services database.

6. A system for verifying service-provider activity at a location of interest, the system comprising:
one or more hardware processors;
a user device including a client application configured to obtain a location of interest associated with a user;
a security platform including a services database populated from one or more schedule databases of service providers, wherein the client application is configured to query the services database using the location of interest to obtain information indicating whether authorized service-provider personnel are scheduled to be present near the location of interest and to present at least a portion of that information to the user for verification.

7. The system of claim 6, wherein the client application is configured to obtain the location of interest using GPS or location services of the user device.

8. The system of claim 6, wherein the security platform is configured to access the schedule databases via an application programming interface.

9. The system of claim 6, wherein communications between the client application and the security platform are secured using HTTPS and/or TLS.

10. The system of claim 6, further comprising an authentication module configured to use JSON Web Tokens with expiring tokens.

11. The system of claim 6, wherein the client application is configured to present identity details of personnel to enable cross-reference with data obtained from the services database.

12. The system of claim 6, wherein the services database is indexed by location data associated with the location of interest to facilitate retrieval.

13. The system of claim 6, wherein the client application is implemented using Kotlin Multiplatform or React Native to provide shared logic with platform-specific user interfaces.

14. The system of claim 6, wherein the security platform is implemented using a monolithic TypeScript architecture employing Fastify and/or NestJS.

15. The system of claim 6, wherein the client application is configured to present a confirmation control to acknowledge scheduled service activity and a date-selection control to modify scheduling.

16. The system of claim 6, wherein the client application is configured to present status indicators reflecting scheduled service-provider activity.

17. The system of claim 6, wherein the security platform is configured to facilitate secure point-to-point communications between service-provider systems and the client application to mitigate spoofing.

18. The system of claim 6, wherein the security platform is configured to receive event-driven updates from service-provider scheduling systems and publish changes to the services database for retrieval by the client application.

19. One or more tangible processor-readable storage media embodied with instructions for executing on one or more processors and circuits of a computing device a process for verifying service-provider activity at a location of interest, the process comprising:
obtaining, by a client application, a location of interest associated with a user;
querying, by the client application, a services database populated from one or more schedule databases of service providers;
receiving, by the client application, information from the services database indicating whether authorized service-provider personnel are scheduled to be present near the location of interest; and
presenting, by the client application, a user interface enabling verification of service-provider presence.

20. The one or more tangible processor-readable storage media of claim 19, wherein the instructions cause the client application to present a landing screen with an address input and status indicators reflecting scheduled activity.
